(19) United States
(12) Patent Application Publication
(10) Pub. No.: US 2024/0309568 A1
(43) Pub. Date: Sep. 19, 2024

(54) STRUCTURES AND METHODS OF USE OF MICRO-RESOLUTION KNITTED MOSQUITO BITE BLOCKING TEXTILES

(71) Applicants: AUBURN UNIVERSITY, Auburn (AL); CARNEGIE MELLON UNIVERSITY, Pittsburgh, PA (US)

(72) Inventors: John F. BECKMAN, Pittsburgh, PA (US); Brian HOLT, San Diego, CA (US); James L. MCCANN, Pittsburgh, PA (US)

(21) Appl. No.: 18/681,236

(22) PCT Filed: Aug. 4, 2022
(86) PCT No.: PCT/US2022/074533

§ 371 Date: Feb. 5, 2024

Related U.S. Application Data
(60) Provisional application No. 63/229,296, filed on Aug. 4, 2021.

(51) Int. Cl. D04B 1/18; A01M 29/00; A41D 27/00; D04B 1/16

(52) U.S. Cl. CPC D04B 1/18; A41D 27/00; D04B 1/16; A01M 29/00; D10B 2201/02; D10B 2331/04; D10B 2331/06; D10B 2331/12; D10B 2501/04

(57) ABSTRACT

The present disclosure relates to structures and methods of use of textiles for protection, and more particularly. relates to single layer knitted structures that can be worn as garments to block mosquito bites. The knit structures of the present embodiments can include single layer structures having a unique geometric combination of yarn properties and textiles to block mosquito bites in a single. comfortable layer of fabric. The knit structures can include one or more controllable parameters that can be adjusted to increase and/or decrease the bite blocking ability of the knit structure.

### CROSS-REFERENCE TO RELATED APPLICATIONS

This application claims the benefit of U.S. Provisional Patent Application Ser. No. 63/229,296, filed on Aug. 4, 2021, entitled “STRUCTURES OF SINGLE LAYER MICRO-RESOLUTION KNITTED MOSQUITO BITE BLOCKING TEXTILES,” the entire content of which is hereby incorporated by reference in its entirety.

### FIELD

The present disclosure relates to structures and methods of use of textiles for protection, and more particularly, relates to single layer knitted structures that can be worn as garments to block mosquito bites.

### BACKGROUND

While mosquitos are a vital part of the world's ecosystem, they are a nuisance to humans in a variety of ways. In addition to mosquito bites causing an uncomfortable itch, mosquitos, especially those in warmer climates, can sometimes carry and transmit a wide variety of vector borne diseases. Zika, dengue, malaria, West Nile virus, and filariasis are all potentially fatal diseases that are carried and spread by mosquitos throughout the world. In the case of malaria, for example, nearly a half million people die each year worldwide. Despite mosquito control measures being taken around the world, disease-carrying mosquitos continue to breed and reproduce. Moreover, in some environments, mosquito populations are controlled by insecticides which promote resistance and are detrimental to the environment. Recent advances in mosquito genetics and biological control have taken steps to lower mosquito populations without insecticides, but these still fundamentally alter earth's ecology in modest ways.

In an effort to protect themselves from the nuisance of being bitten by mosquitos on an individual level, humans have used textiles as a pragmatic core of effective mosquito-borne disease prevention in the form of clothing. These textiles can acts as barriers from mosquitos, preventing bites and therefore curtailing spread of disease. Use of clothing for bite blocking has several limitations. First, designing clothing to mechanically block the mosquito is difficult due to the mosquitos'small size. The mosquito proboscis is constituted of an outer labium. At feeding, the labium retracts exposing the fascicle. The fascicle is a repertoire of serrated blades and microneedles bound by liquid surface tension. The labrum (Lb) is a beveled needle that draws blood. Adjacent the labrum are paired mandibular (md) and maxillary (mx) stylets. Maxillary stylets saw skin at a vibrational frequency of 30 Hz to reduces puncture force. Serrated maxillary stylets are necessary for mosquito biting. The fascicle can bend at 90° angles, has sensilla, and is controlled by delicate musculature. The length of proboscis in Aedes aegpyti is 2.32 mm long, width of the fascicle 60 μm, and the labrum about 25μm in diameter.

Second, clothing does not block mosquito proboscises. Specifically, common clothing textiles are the products of weaves or knits, with fibers that are pulled and spun into yarns. These yarns are weaved or knitted in crosshatch patterns or intertwined loops having microscopic pores where threads intertwine, with the pores being larger than mosquito fascicles. Further, clothes thick enough to physically exclude the length proboscis' length, e.g., clothing with no pores such as leather and latex, are uncomfortable in heat, which is the climate in which most disease-carrying mosquitos live.

In a trend toward comfort and functionality, modern textile design mimics nature. Humans now wear garments that recapitulate functions of human skin. Compression clothes are made of elastic materials designed to apply compressive forces to the body. These compression clothes do not prevent bites, and are actually worse because the added layer decreases a human's ability to sense mosquito landing events.

Accordingly, there is a need for a textile structure that can provide bite blocking while maintaining comfort for the wearer in most, if not all, climates.

### SUMMARY

According to one aspect of the present disclosure, a method of using a textile for bite blocking comprises:

preparing a single layer fabric, the fabric comprising a plurality of fibers knitted to form a knit structure having a plurality of pores formed between for covering a portion of a body of a user, wherein the single layer fabric is a weft knitted fabric, and wherein adjusting the knit structure increases or decreases the propensity of the textile to protect from bites without adjusting a size of the space between adjacent fibers.

In another aspect, a textile for use in bite blocking, comprises:
a knit structure composed of one or more fibers, the fibers being knitted into one or more of a single jersey knit, a skip jersey knit, an interlock knit, or a half-cardigan knit wherein the bite blocking of the knit structure is configured to be changed by adjusting one or more of the one or more controllable parameters comprising: fiber diameter, spandex content, fiber tuft, or post-knit heat treatment.

Additional embodiments, features, and advantages of the disclosure will be apparent from the following detailed description and through practice of the disclosure. The process and compounds of the present disclosure can be described as embodiments in any of the following enumerated clauses. It will be understood that any of the embodiments described herein can be used in connection with any other embodiments described herein to the extent that the embodiments do not contradict one another.

1. A method of using a textile for bite blocking, the method comprising: preparing a single layer fabric, the fabric comprising a plurality of fibers knitted to form a knit structure having a plurality of pores formed between for covering a portion of a body of a user,
wherein the single layer fabric is a weft knitted fabric, and
wherein adjusting the knit structure increases or decreases the propensity of the textile to protect from bites without adjusting a size of the space between adjacent fibers.

2. The method of clause 1, wherein the knit structure is one or more of a jersey knit, a jersey skip knit, an interlocking knit, or a half-cardigan knit.

3. The method of clause 1 or clause 2, further comprising adjusting one or more controllable parameters of the textile to change an ability of the textile to block from bites.

4. The method of clause 3, wherein the one or more controllable parameters comprise fiber diameter, spandex content, fiber tuft, or post-knit heat treatment.

5. The method of clause 4, wherein the adjustment increases or decreases the propensity of the textile to bite block without adjusting a size of the pores between adjacent fibers.

6. The method of any one of clauses 1-5, wherein a fiber diameter is in a range of about 250 microns to about 500 microns.

7. The method of any one of clauses 1-6, wherein the knit structure comprises a spandex content in approximately a range of about 3% to about 15% .

8. The method of any one of clauses 1-7, wherein the knit structure comprises about 78% cotton, about 19% polyester, and about 3% spandex content.

9. The method of any one of clauses 1-8, further comprising adjusting a pore size between the fibers to shrink the space between one or more whales and one or more course.

10. The method of clause 9, wherein adjusting further comprises washing the interlock knit structure to shrink one or more pores between the fibers.

11. The method of any one of clauses 1-10, wherein bite blocking of the textile reduces the number of mosquito bites in a designated area of a subject by an amount approximately in a range of about 75% to about 100% as compared to an average article of clothing worn in the designated area.

12. The method of any one of clauses 1-11, increasing fiber diameter used in the knit structure is capable of enhancing blocking properties thereof.

13. The method of any one of clauses 1-12, further comprising tightening the fibers to dispose a portion of one or more fibers in one or more of the pores.

14. A textile for use in bite blocking, comprising:

a knit structure composed of one or more fibers, the fibers being knitted into one or more of a single jersey knit, a skip jersey knit, an interlock knit, or a half-cardigan knit, wherein the bite blocking of the knit structure is configured to be changed by adjusting one or more of the one or more controllable parameters comprising: fiber diameter, spandex content, fiber tuft, or post-knit heat treatment.

15. The textile of clause 14, wherein a longitudinal axis that is positioned perpendicular to a surface of the knit structure passes through one or more fibers.

16. The textile of clause 14 or clause 15, wherein the knit structure is a single layer structure.

17. The textile of any one of clauses 14-16, wherein the knit structure is unitary.

18. The textile of any one of clauses 14-17, wherein the knitted fibers are a weft knitted fabric.

19. The textile of any one of clauses 14-18, further comprising a spandex content in approximately a range of about 3% to about 15%.

20. The textile of any one of clauses 14-19, wherein the tuft value can be approximately in a range of about 10% to about 100%

21. The textile of any one of clauses 14-20, wherein the fibers have approximately nine stitch lengths therebetween.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

This disclosure will be more fully understood from the following detailed description taken in conjunction with the accompanying drawings, in which:

FIG. 1A illustrates a prior art schematic view of a process of weave manufacturing using a plurality of warp and weft fibers;

FIG. 1B illustrates a prior art schematic view of a process of knit manufacturing that uses single fibers and draws loops through loops to form courses (rows) and whales (columns) to form a sheet;

FIG. 1C illustrates a prior art schematic view of symbology used in knit diagrams;

FIG. 1D illustrates a prior art schematic of primitive movements of knitting machines;

FIG. 1E illustrates a prior art schematic of a knit diagram demonstrating a repeating pattern;

FIG. 2A is a top perspective view of a single jersey knit having a fiber diameter of about 282 μm;

FIG. 2B is a top perspective view of a single jersey knit having a fiber diameter of about 328 μm;

FIG. 2C is a top perspective view of a single jersey knit having a fiber diameter of about 433 μm;

FIG. 2D is a top perspective view of a jersey skip knit having a spandex content of about 0%;

FIG. 2E is a top perspective view of a jersey skip knit having a spandex content of about 3%;

FIG. 2F is a top perspective view of a jersey skip knit having a spandex content of about 3%;

FIG. 2G illustrates a top perspective view of an interlock knit having a stitch length of eleven;

FIG. 2H illustrates a top perspective view of an interlock knit having a stitch length of ten;

FIG. 2I illustrates a top perspective view of an interlock knit having a stitch length of nine;

FIG. 3 is a top perspective view of the jersey skip knit of FIGS. 2D-2F of the present embodiments;

FIG. 4 is a top perspective view of the interlock knit of FIGS. 2G-2I of the present embodiments;

FIG. 5 is a schematic view of a knit structure of a half-cardigan combined with spandex;

FIG. 6A is a top perspective view of the interlock knit of FIG. 4 before heat treatment; and

FIG. 6B is a top perspective view of the interlock knit of FIG. 6A after heat treatment.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

To the extent features, sides, objects, arms, beams, sensors, steps, or the like are described as being “first,” “second,” “third,” etc., such numerical ordering is generally arbitrary, and thus such numbering can be interchangeable. Still further, in the present disclosure, like-numbered components and/or like-named components of various embodiments generally have similar features when those components are of a similar nature and/or serve a similar purpose, unless otherwise noted or otherwise understood by a person skilled in the art. To the extent the present disclosure includes prototypes, mock-ups, schematic illustrations, bench models, or the like, a person skilled in the art will recognize how to rely upon the present disclosure to integrate the techniques, systems, devices, and methods into a product. The present disclosure may use or describe particular components using interchangeable or related terms. By way of non-limiting example, the terms “knit” and “knit structure” may be used interchangeably with one another to refer to the knitted structures of the materials of the present embodiments.

The present disclosure generally relates to knitted structures that block mosquito bites. In some aspects, the knitted structures of the present embodiments can create a barrier that prevents mosquitos from biting through the knitted structure and/or landing on the textile. Knit structures of the present embodiments can include single layer structures having a unique geometric combination of yarn properties and textiles to block mosquito bites in a single, comfortable layer of fabric. Single layer fabrics can promote comfort while also minimizing an amount of fiber used, thereby reducing costs of manufacture. In some embodiments, these single layer fabrics can include a jersey knit, a jersey skip knit, and an interlocking knit that can be worn as a garment to cover the entire body or over an area of high attractiveness, e.g., feet upper back, and/or shoulders. One or more controllable parameters of the knit structures can be adjusted to further increase bite blocking capabilities of the knit structures.

A person skilled in the art will recognize that a textile that blocks or substantially blocks mosquito bites for the purpose of the present disclosure is a textile that reduces the number of mosquito bites in a designated area of a subject by an amount approximately in a range of about 75% to about 100% as compared to an average article of clothing worn in the designated area, or by an amount of about 87% as compared to an average article of clothing worn in the designated area. In addition, while the textile is discussed in terms of mosquito bite blocking, a person skilled in the art will recognize that the textile can apply to other biting insects, e.g., ticks, fleas, spiders, flies, gnats, and so forth, as well as scorpions, mice, snakes, and other animals having the propensity to bite.

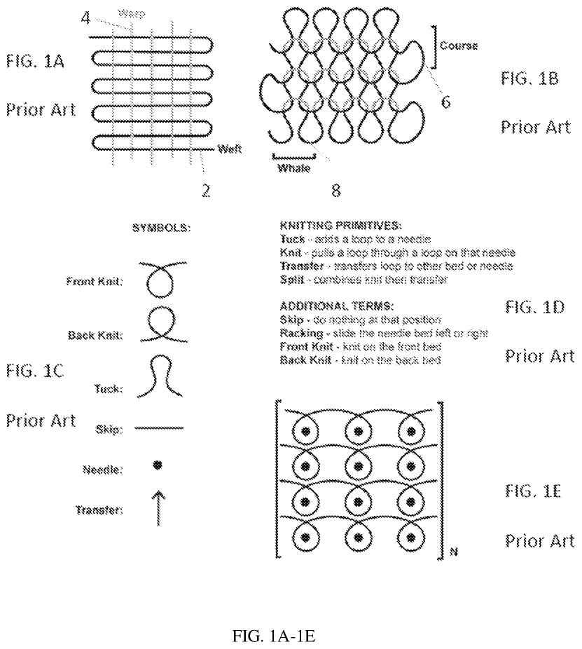

FIGS. 1A-1E illustrate conventional techniques and relevant terminology for garment manufacture using textiles. Conventional modern clothing can be manufactured as weaves or knits. As shown in FIG. 1A, weaving is a process of intertwining threads with over/under patterns to interlace a plurality of independent weft fibers 2 and warp fibers 4. Exemplary conventional weaves can include twill, oxford, pinpoint oxford, royal oxford and poplin, among others. During testing these weaves did not block bites. Notably, modern clothing including items such as compression heat gear, socks, and garments advertised as including insect protection did not block bites, nor did a protective horse mesh. Simple microscopy revealed that these textiles were full of spaces through which mosquito could probe. Moreover, the presence of some of these weaves even reduced sensation of mosquito landing events, which can be worse than landing on bare skin due to the mosquito not being detected by the wearer until the bite has already occurred.

FIG. 1B illustrates a conventional process of knit manufacturing. As shown, knit manufacturing includes using fibers and drawing loops through loops to form a sheet. For example, drawing a loop through another loop can form courses 6 and whales 8 that can form sheets of a textile that can be layered to form a clothing garment. Unique knit patterns can be scientifically described through symbol diagrams that convey the knit geometry, termed knit diagrams, which are shown in more detail in FIGS. 1C and 1D. The written knit code can be translated into robotic machine primitives interpretable by modern flatbed Computer Numerical Control (CNC) knitting machines which can knit complicated structures with simple up-down needle movements. For example, front knits can include pulling a loop onto the front needle bed and a back knit onto the back needle bed. Tuck can draw a loop onto a needle without pulling it through a prior loop. Skip can include passing a needle while dots represent needles and arrows represent transfers of loops from back to front or vice versa. FIG. 1E illustrates an example of a knit diagram representing a repeating pattern that is used in knit manufacture.

Full body testing can be used to identify primary probing spots of female Aedes aegypti. For example, as discussed in greater detail below, data collected can illustrate that mosquitos predominantly attack lower legs, feet, and upper back. In view of these findings, unexpectedly, wearing long sleeves as compared to a T-shirt only increases your area of protection from mosquitos by ˜14% , which is not even a statistically significant difference. In view of this data, various designs of clothing can be engineered to block mosquito bites that place an emphasis on areas in which attacks are predominant. For example, in some embodiments, clothing can be constructed utilizing blocking textile knits in regions of high mosquito attack and regions where garments cling to skin. In addition, these garments can be mixed with loose open knits in other areas of low attack and where the textile is non-form fitting to maximize comfortability. In some aspects, an entire clothing item is constructed entirely of mosquito bite blocking textile knits. Further still, in certain aspects, the textiles of the present embodiments can be used in combinatorial garments that implement specific blocking structures in regions of high attack and more comfortable breathable textile structures in regions of low attack.

Few actual weaved and knitted structures have been rigorously probed for their ability to block bites. It will be appreciated that due to few machine primitives and the combinatorial variables in weaves and knits discussed above with respect to symbols and nomenclature, a near unlimited number of textile structures exist for garment manufacturing. With virtually no identified, predictable solutions that have a reasonable expectation of success for bite blocking, textile configurations that block mosquito bites can be difficult to identify. Moreover, where the prior art gives either no indication of which parameters were critical or no direction as to which of many possible choices is likely to be successful, the knit structures of the present embodiments yield unexpected results.

Weaving is a linear process of interlacing (over and under), while knitting is a recursive looping process. By default, both methods produce microscopic pores where threads intertwine. Therefore, the clothing manufacturing process always produces pores larger than the mosquito fascicle between yarns. Nevertheless, the knit structures of the present embodiments can provide unexpected bite blocking capabilities despite the spaces between the fabric being larger than the proboscis of the mosquito.

It will be appreciated that production of the knit structures of the present embodiments can be automated. For example, the CNC machines can be programmed to create one or more of the geometrical knit structures of the present embodiments.

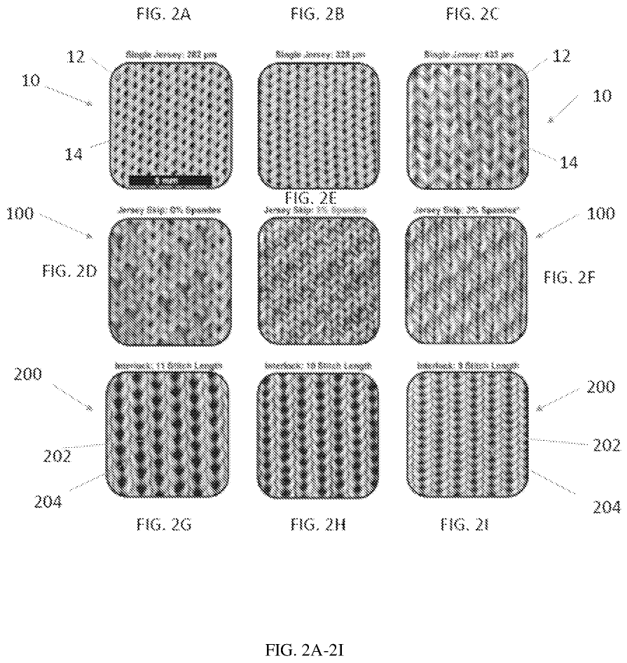

Among knitted structures, weft knits of the present embodiments showed superior blocking performance as compared to warp knits Weft knits tend to have higher elasticity and shrinkage after wash, which allows them to be more customizable and also can directly increase the bite blocking ability of knits. FIGS. 2A-2I illustrate knit structures that are configured to provide superior bite blocking. As shown in FIG. 2A, a single jersey knit 10 can include a single layer knit structure that is a weft knitted fabric. Single jersey fabrics 10 can be made using a knitting machine with one row of needles. Single jersey knit structures produce a layer of fabric that is soft, light, and drapes easily making this type of knit for sports t-shirts or leggings due to its high breathability.

A person skilled in the art will recognize that a size of the space, or pore size 12, between adjacent fibers 14 in a knit or weave can increase or decrease the quality of bite blocking of the textile. In some aspects, decreasing a pore size 12 can improve bite blocking due to less space being disposed between the fibers 14 that the mosquitos can use to access a person's body. Decreasing a size of the pore 12 to a fiber-fiber distance that is smaller than the proboscis of the mosquito can be impractical, however, as such textiles can be very dense due to the presence of a large number of fibers, which can be expensive. Moreover, production of such dense textiles can be heavy, hot, and/or uncomfortable to wear, while not allowing sufficient breathability to the areas of the body that are covered. The fibers 14 can be composed of cotton, polyester, nylon, spandex, acrylic, and so forth.

In addition to knit structure, additional variables, or controllable parameters, can contribute to improvements or worse of bite blocking. Moreover, some of the controllable parameters can unexpectedly have a greater impact on bite blocking of the textile than controlling the pore size 12. For example, one or more of fiber diameter, spandex content, fiber tuft, post-knit heat treatment can be modified. Unexpectedly, adjusting these controllable parameters can increase and/or decrease the propensity of the textile to block from bites without adjusting a size of the space, or pore size, between adjacent fibers in the textile. It will be appreciated that the controllable parameters can be adjusted independent of one another and/or in combination with one or more of another of the controllable parameters to impact bite blocking ability of the textile.

For example, increasing fiber diameter used in the knit structure can enhance blocking properties thereof. For example, as shown in FIGS. 2A-2C, for fiber diameters that are approximately in a range of about 282.17 microns to about 433.33 microns, larger fibers 14, such as those in FIG. 2C, blocked better than smaller fibers of FIG. 2A. Larger fiber diameters can create a tighter single jersey structure to minimize the number and size of pores 12 between fibers, thereby forcing mosquito to have to penetrate fiber to bite.

In some embodiments, spandex content of the fibers can modify mosquito bite blocking capabilities of the knit structure. For example, spandex can geometrically compress knits (post-knitting) into alternate geometries with condensed stitch density. A person skilled in the art will recognize that stitch density is the distance between individual stitches in a column or row. In some embodiments, superior blocking was observed in jersey skip knit structures 100, such as those shown in FIGS. 2D-2F, having a spandex content, especially when compared to those without a spandex content. In some embodiments, spandex content in approximately a range of about 3% to about 15% exhibited superior blocking performance. It will be appreciated that the spandex content can be combined with other materials to form the knit structure having bite blocking properties. For example, the knits having a 3% spandex content, e.g., a knit having about an 97.03% polyester and about 2.97% spandex content of FIG. 2E and a knit having about 78% cotton, about 19% polyester, and about 3% spandex content of FIG. 2F had superior bite blocking compared to the knit in FIG. 2D which lacked spandex. In an alternate embodiment, a knit structure using about 85% vivylon and about 15% spandex jersey skip showed partial blocking.

In some embodiments, fiber tuft or fuzziness of the textile can impact bite blocking. For example, tuft can create discomfort for mosquitos that probe through a fabric having a higher tuft value. In some embodiments, the tuft value can be measured as a distance that the fibers spread out from a core diameter of the fiber, with 100% tuft being an effective doubling of the diameter of the fiber. In some embodiments, the tuft value can be approximately in a range of about 10% to about 100% , approximately in a range of about 15% to about 75% , approximately in a range of about 20% to about 50% , and/or approximately in a range of about 25% to about 35% . Discomfort can result in mosquitos spending less time on the fabric, thereby reducing duration during which the mosquito can bite.

It will be appreciated that, in some embodiments, tuft can be measured as a length of fabric spread out from a core diameter of the fiber. For example, for a fiber diameter of about 433 microns, as shown in FIG. 2C, a 25% fiber tuft value would suggest that the fabric extends about 108 microns from the core diameter of the fiber. In such embodiments, the tuft value can be approximately in a range of about 10% to about 100% , approximately in a range of about 15% to about 75% , approximately in a range of about 20% to about 50% , and/or approximately in a range of about 25% to about 35%.

In some aspects, stitch length can impact bite blocking. For example, in some embodiments, decreasing the stitch length can increase blocking of the interlock knit. The interlock knit is shown in greater detail in FIGS. 2G-2I, with stitch lengths of 11 stitches, 10 stiches, and 9 stitches, respectively, being shown. Less stitch lengths between fibers can result in smaller pores 34 formed between fibers 32, thereby decreasing a surface area through which the mosquito proboscis can penetrate. It will be appreciated that blocking can therefore be achieved by a single layer knitted structure. For example, when compared to a bare arm, a 100% acrylic single jersey knit and an interlock knit showed a 95.7% and 68.2% reduction in bites respectively. It will be appreciated that the bite blocking performance of the single jersey knit can be attributed to the thickness of the of the knit as well as to the tuft of the acrylic yarn of the acrylic single jersey knit.

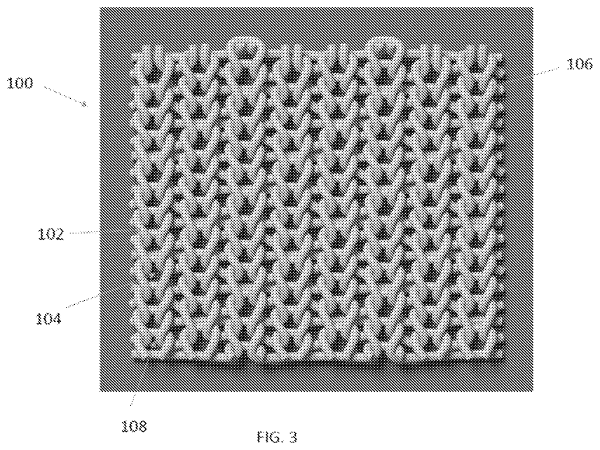

FIG. 3 illustrates the jersey skip knit structure of FIGS. 2D-2F in greater detail. As shown, the jersey skip 100 can include a plurality of fibers 102 that are looped through one another to form a series of courses 106 and whales 108. The courses 106 and whales 108, in turn, can be strung through one another to form a single layer, unitary sheet to reduce the pore size 104. For example, the series of courses 106 and whales 108 in the jersey skip are spaced closer together than in single jersey (having a loop gap of approximately 312 microns), reducing a space between the fibers 102 and improving bite blocking ability of the knit structure. The jersey skip 100 allows for improvement of bite blocking while remaining a single layer knit structure that has strong breathability. The comparable improvement in bite blocking can be attributed to a reduction of pore size 104 of the jersey skip that can be more than 100-fold as compared to the single jersey, e.g., less than about 10 microns. Moreover, the spandex content of the jersey skip 100 knit structure can provide enhanced bite blocking for this type of knit structure, as discussed above with respect to FIGS. 2E and 2F. For example, a spandex content of about 3% allows the jersey skip knit 100 to bite block while maintaining comfort and increasing elasticity. The mechanism of blocking for the jersey skip 100 is that the spandex and knit pattern combine synergistically to contort the structure in a way that shields and removes the inter-loop gaps while also layers single fibers below any such gaps.

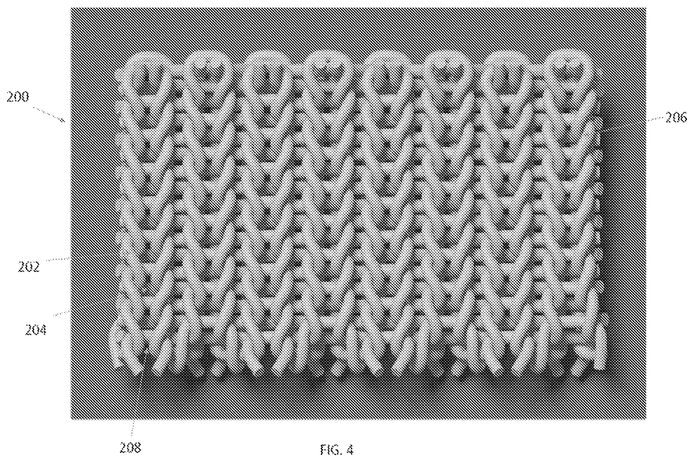

FIG. 4 illustrates the interlocking knit 200 structure of FIGS. 2G-2I in greater detail. As shown, the interlocking knit 200 includes a plurality of fibers 202 that are looped through one another to form a series of courses 206 and whales 208. The loops are formed on top of one another that are strung through one another to form a unitary sheet to reduce the size of the pores 204. The interlocking knit 200 can be a single layer knit structure and/or can be folded onto itself to form a multilayer knit structure, as shown, where a series of loops rests on a second series of loops. This second series of loops can sit behind the first series of loops to block the pores 204 of the first series without closing the gaps between the loops of the first series to provide increased bite blocking. In the interlocking knit 200, the fibers 202 can be knitted with rows that alternate between being raised and lowered with two rows of stitches. The rows of stitches are created one behind the other, using two rows of needles that cross over each other to construct it. Due to the presence of two rows, interlock knit fabric can be known as a double knit fabric where the rows become “interlocked” as the fabric is knitted. The interlocked, double rows also create a fabric that is thicker than regular knit fabric, while having soft and smooth texture. In some embodiments, the interlock structure 200 can include a high stiffness, thickness, and lack of stretch, which supports its properties of superior bite blocking.

The interlocking knit 200 can provide bite blocking without having a spandex content, e.g., having a spandex content of about 0%. For example, the interlocking knit 200 can provide that a knit structure alone can provide bite blocking independent of content of the fibers of the knit and/or independent of the pore size between individual fibers of a knit.

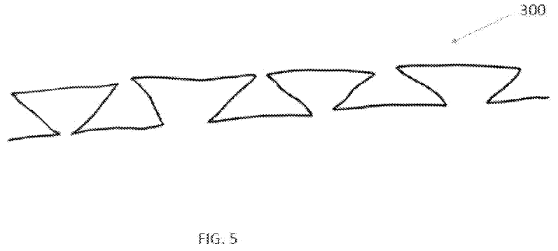

In some embodiments, adding spandex to a knit structure can increase its bite blocking abilities. FIG. 5 illustrates a half-cardigan knit structure 300 modified with spandex. Half-cardigans knitted without spandex, e.g., 100% acrylic can provide poor blocking. Once modified using about 3% spandex, the half-cardigan, which takes on the illustrated three-dimensional shape when knitted, provides total bite blocking. Larger spandex contents over a certain threshold value, e.g., up to and including 100% spandex content, can lessen bite blocking of the knit structure, or eliminate it altogether. In such embodiments, the contracting forces can be distributed evenly through the textile, which can contract enough to open up holes therein. Therefore, a spandex content of a knit structure should be such that the knit structure has sufficient force to close the gaps but not so much as to exert force to pull the fabric open. In some embodiments, the threshold value of spandex content can be about 5% spandex content, about 10% spandex content, about 20% spandex content, about 50% spandex content, and/or about 75% spandex content. Single jersey 10, jersey skip knits 100 and interlocking knits 200 have not been previously utilized in bite blocking. For example, conventional fabrics for bite blocking can be weaves, as noted above, and knits having multiple layer structures, for example. A person having ordinary skill in the art would not look to these single layer knit structures for bite blocking due to single layer knits not being recognized as having sufficient bite blocking as compared to conventional products like Rynoskin, which allege superior bite blocking performance. Moreover, the jersey skip knit 100 and the interlocking knit 200 structure can use more yarn than and are a more complex knit than other knit structures used for bite blocking purposes. A person skilled in the art would therefore look to knit structures that use less yarn resources to create a bite blocking textile, while failing to appreciate the superior bite blocking offered by the jersey skip knit 100 structure and the interlocking knit 200 structure.

The superior bite blocking of the jersey skip knit 100 structure and the interlocking knit 200 structure can be attributed to the series of courses 106, 206 and whales 108, 208 respectively formed through each. For example, when the fibers 102, 202 are tightened, each of the jersey skip 100 knit structure and the interlocking knit 200 structure have a course 106, 206 or a whale 108, 208 disposed substantially within an opening of the pore 102, 202 to prevent direct access to a person's skin below. For example, for each of the jersey skip 100 knit structure and the interlocking knit 200 structure, a longitudinal axis drawn perpendicular to a surface of the knit structure passes through one or more fibers. Such an intertwining of the fibers 102, 202 can require a mosquito to navigate its proboscis through an indirect path through the knit, reducing the chances that the proboscis can make contact with the skin beneath.

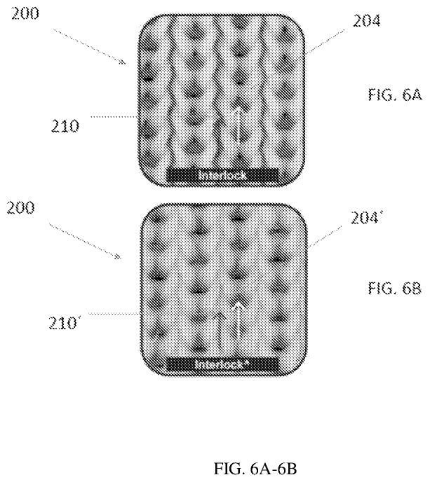

In some embodiments, post-knit fabric shrinking can contribute to bite blocking. FIGS. 6A-6B illustrates the interlocking knit in an unwashed form (FIG. 6A) and after washing (FIG. 6B). For example, knit structures can be shrunk via a wash and dry cycle, which can tighten the pores 203 and the inter-knit space 210 by shrinking the inter-whale and inter-loop space. As shown once shrunk, post-knit shrunk interlock knits performed better than un-shrunk knits due to the smaller pores 204′ and inter-knit space 210′.

The knit structures of the present embodiments can be used to design various forms of clothing that is engineered to block mosquito bites. In some embodiments, the garment can be constructed to utilize blocking textile knits in regions of high mosquito attack and regions where garments cling to skin. These garments can be mixed with loose open knits in other areas of low attack, e.g., torso and arms, and where the textile is non-form fitting to maximize comfortability. In alternate embodiments, the entire clothing item is constructed entirely of mosquito bite blocking textile knits to protect both regions of high attack and low attack. In additional aspects, the knit structures can be used in clothing and/or covering for pets, farm animals, zoo animals, and the like, some of whom may also be sensitive to mosquito-borne disease.

The single layer knit structures of the present embodiments can have a high degree of comfort. For example, due to less fabric being used, these single layer knit structures can be light, easy to wear, and have high air permeability. Air permeability quantifies how breathable a textile is. To measure air permeability, compressed air can be passed at 100 psi through the textile and measure its force on the other side by quantifying its ability to move a substrate (sugar crystals) a given distance, with textiles that allow for more air to pass through are more comfortable. Comfort can be measured by a combination of experiments including a 9-factor comfort score measuring grittiness, fuzziness, thickness, tensile stretch, hand friction, fabric to fabric friction, force to compress, stiffness, and noise intensity, among others. Comfort scores for the single jersey 10, jersey skip 100, and interlock 200 knit structures can be superior to conventional weaves. In some embodiments, the interlock knit 200 structure can incorporate spandex/elastic to increase comfort.

Yarns and Knitting Manufacturing. Prototype knit diagrams can be assembled in Stoll's M1 Plus software and knitted using a Stoll ADF Flatbed Knitting Machine in the Auburn War Needle knitting lab. The knits can be created using various yarns from varied sources. A standard control yarn can be 100% polyester—size 2/150/96 (number of plies/denier of each ply/number of filaments in each ply) with diameter 282 microns. knitted textiles are sewn into sleeves using standard Serger machine (Brother International).

One skilled in the art will appreciate further features and advantages of the present disclosure based on the above-described embodiments. Accordingly, the disclosure is not to be limited by what has been particularly shown and described. Further, a person skilled in the art, in view of the present disclosures, will understand how to implement the disclosed systems and methods provided for herein in conjunction with other knit structures and/or garments. All publications and references cited herein are expressly incorporated herein by reference in their entireties.

1. A method of using a textile for bite blocking, the method comprising:
preparing a single layer fabric, the fabric comprising a plurality of fibers knitted to form a knit structure having a plurality of pores formed between for covering a portion of a body of a user,
wherein the single layer fabric is a weft knitted fabric, and
wherein adjusting the knit structure increases or decreases the propensity of the textile to protect from bites without adjusting a size of the space between adjacent fibers.

2. The method of claim 1, wherein the knit structure is one or more of a jersey knit, a jersey skip knit, an interlocking knit, or a half-cardigan knit.

3. The method of claim 1, further comprising adjusting one or more controllable parameters of the textile to change an ability of the textile to block from bites.

4. The method of claim 3, wherein the one or more controllable parameters comprise fiber diameter, spandex content, fiber tuft, or post-knit heat treatment.

5. The method of claim 4, wherein the adjustment increases or decreases the propensity of the textile to bite block without adjusting a size of the pores between adjacent fibers.

6. The method of claim 1, wherein a fiber diameter is in a range of about 250 microns to about 500 microns.

7. The method of claim 1, wherein the knit structure comprises a spandex content in approximately a range of about 3% to about 15%.

8. The method of claim 1, wherein the knit structure comprises about 78% cotton, about 19% polyester, and about 3% spandex content.

9. The method of claim 1, further comprising adjusting a pore size between the fibers to shrink the space between one or more whales and one or more course.

10. (canceled)

11. The method of claim 1, wherein bite blocking of the textile reduces the number of mosquito bites in a designated area of a subject by an amount approximately in a range of about 75% to about 100% as compared to an average article of clothing worn in the designated area.

12. The method of claim 1, increasing fiber diameter used in the knit structure is capable of enhancing blocking properties thereof.

13. The method of claim 1, further comprising tightening the fibers to dispose a portion of one or more fibers in one or more of the pores.

14. A textile for use in bite blocking, comprising:
a knit structure composed of one or more fibers, the fibers being knitted into one or more of a single jersey knit, a skip jersey knit, an interlock knit, or a half-cardigan knit,
wherein the bite blocking of the knit structure is configured to be changed by adjusting one or more of the one or more controllable parameters comprising: fiber diameter, spandex content, fiber tuft, or post-knit heat treatment.

15. The textile of claim 14, wherein a longitudinal axis that is positioned perpendicular to a surface of the knit structure passes through one or more fibers.

16. The textile of claim 14, wherein the knit structure is a single layer structure.

17. The textile of claim 14, wherein the knit structure is unitary.

18. The textile of claim 14, wherein the knitted fibers are a weft knitted fabric.

19. The textile of claim 14, further comprising a spandex content in approximately a range of about 3% to about 15%.

20. The textile of claim 14, wherein the tuft value can be approximately in a range of about 10% to about 100%.

21. The textile of claim 14, wherein the fibers have approximately nine stitch lengths therebetween.
